(19) United States
(12) Patent Application Publication
(10) Pub. No.: US 2025/0369574 A1
(43) Pub. Date: Dec. 4, 2025

(54) CRYOGENIC FLUID STORAGE UNIT AND VEHICLE COMPRISING SUCH A UNIT

(71) Applicant: Faurecia Hydrogen Solutions France, NANTERRE (FR)

(72) Inventor: Frederic GREBER, ECOT (FR)

(21) Appl. No.: 19/220,264

(22) Filed: May 28, 2025

(30) Foreign Application Priority Data
May 31, 2024 (FR) 24 05720

(51) Int. Cl. F17C 13/04; H02K 5/20; H02K 7/08; H02K 9/19

(52) U.S. Cl. CPC F17C 13/04; H02K 5/203; H02K 7/08; H02K 9/19; F17C 2270/0168

(57) ABSTRACT

A cryogenic fluid storage unit comprises an internal reservoir, an external reservoir, and a cryogenic fluid transfer member housed in an intermediate space between the internal reservoir and the external reservoir. The cryogenic fluid transfer member comprising a body delimiting a chamber, an intake, and a discharge comprising at least one exhaust duct placing the chamber in fluid communication with a cryogenic fluid outlet outside the storage unit. The cryogenic fluid transfer member further comprises a movable member configured to move relative to the body by varying a volume of the chamber, a motor, and a mechanical transmission transmitting a movement from an output shaft of the motor to the movable member. The at least one exhaust duct is configured to cool the motor.

### CROSS-REFERENCE TO RELATED APPLICATION

This application is a U.S. non-provisional application claiming the benefit of French Application No. 24 05720, filed on May 31, 2024, which is incorporated herein by reference in its entirety.

### TECHNICAL FIELD

The present disclosure relates in general to the storage of a cryogenic fluid.

### BACKGROUND

A storage unit for receiving cryogenic hydrogen is generally designed to withstand internal pressures of between 1 and 27 bar. Above this pressure, the walls of the internal reservoir of the storage unit need to be very thick, and the mass of the storage unit becomes very significant. This is particularly disadvantageous for storage units intended to be installed on board vehicles.

For applications in which hydrogen is to be used in an internal combustion engine, the hydrogen injection pressure is in the range of 40 to 200 bar. Indeed, it is necessary to inject hydrogen directly into the cylinders of the engine when the intake valves are closed, that is when the piston is rising. It is therefore essential to supply the hydrogen at a higher pressure than the current cylinder pressure. In addition, injecting at high pressure produces a more homogeneous mixture and improves combustion quality.

The internal combustion engine must therefore be supplied using a transfer member to compress the cryogenic fluid.

To this end, it is possible to use piston pumps, immersed in the hydrogen stored in the storage unit.

The heat released by the motor of the pump heats up the cryogenic hydrogen, which reduces the possible storage time for cryogenic hydrogen. This heat transfer reduces the dormancy time, which is the storage time before the pressure in the storage unit reaches a maximum storage unit pressure and hydrogen gas release is required.

In this context, the disclosure aims to propose a cryogenic fluid storage unit that addresses this issue.

### SUMMARY

To this end, the disclosure relates to a cryogenic fluid storage unit, the cryogenic fluid storage unit comprising:
an internal reservoir, which internally delimits a storage volume for cryogenic fluid;
an external reservoir, in which the internal reservoir is housed, the internal reservoir and the external reservoir being separated from each other by a low-pressure intermediate space;
a cryogenic fluid transfer member housed in the low-pressure intermediate space, the cryogenic fluid transfer member comprising a body delimiting a chamber, an intake placing the chamber in communication with the storage volume for the cryogenic fluid, a discharge comprising at least one exhaust duct placing the chamber in fluid communication with a cryogenic fluid outlet outside the cryogenic fluid storage unit, a movable member configured to move relative to the body by varying a volume of the chamber, a motor, and a mechanical transmission transmitting a movement from an output shaft of the motor to the movable member;

the at least one exhaust duct being configured to cool the motor.

Because the at least one exhaust duct is configured to cool the motor, the heat released by the motor does not contribute to heating the cryogenic fluid stored in the internal reservoir. This heat is transferred to the flow of cryogenic fluid conveyed outwardly of the storage unit. It is evacuated with the cryogenic fluid.

This heat helps to warm the outgoing cryogenic fluid flow, which is generally an advantage.

The cryogenic fluid storage unit may further comprise one or more of the following features, considered alone or according to any technically possible combinations:
the motor is an electric motor comprising a rotor and a stator equipped with stator windings, the at least one exhaust duct being configured to cool the stator windings;
the cryogenic fluid transfer member comprises a casing in which the motor is housed, the at least one exhaust duct comprising a cooling section arranged in the casing;
the casing and the body are integral;
the at least one exhaust duct comprises an intermediate section fluidically connecting the cooling section to the chamber, the intermediate section being arranged in the body;
the casing is tubular and has a transverse central axis, the cooling section comprising a plurality of transverse portions parallel to the transverse central axis, and a plurality of circumferential portions connecting the transverse portions together;
the casing has a cylindrical part coaxial with the transverse central axis and thickened portions projecting from an external surface of the cylindrical part, the cooling section being arranged in the thickened portions;
the casing is made of cast aluminum or cast steel;
the body comprises flanges carrying bearings for guiding the output shaft of the motor in rotation.

According to a second aspect, the disclosure relates to a vehicle comprising an internal combustion engine having combustion chambers and a cryogenic fluid storage unit having the above features, the cryogenic fluid transfer member discharging the cryogenic fluid into the combustion chambers of the combustion engine.

### BRIEF DESCRIPTION OF THE DRAWINGS

Other features and advantages of the disclosure will become apparent from the detailed description given hereunder, by way of non-limiting indication, referring to the appended figures, among which:

FIG. 1 is a sectional view of a cryogenic fluid storage unit in accordance with the disclosure, taken in a vertical plane containing the central axis of the internal reservoir;

FIG. 2 is a front view of the storage unit shown in FIG. 1, with the bottom of the external reservoir partially removed to reveal the cryogenic fluid transfer member;

FIG. 3 is a sectional view of a part of the storage unit shown in FIGS. 1 and 2, viewed at the angle of arrows III in FIG. 2.

FIG. 4 is a perspective view of the transfer member shown in FIGS. 1 to 3, with a part of the body and a part of the bellows removed to reveal the movable member and the mechanical transmission;

FIG. 5 is a sectional view of the transfer member shown in FIG. 4, taken in a plane containing the output shaft of the motor and the longitudinal direction of movement of the movable member;

FIG. 6 is a perspective view of the cylinder head of the transfer unit, with a partial cutaway to reveal an exhaust valve and an intake valve;

FIGS. 7 and 8 are side views of the transfer member, as seen from arrows VII and VIII respectively in FIG. 4, with the exhaust ducts being shown as dashed lines; and

FIG. 9 is a simplified schematic depiction of a vehicle equipped with an internal combustion engine supplied by the storage unit shown in FIGS. 1 to 8.

### DETAILED DESCRIPTION OF THE DRAWINGS

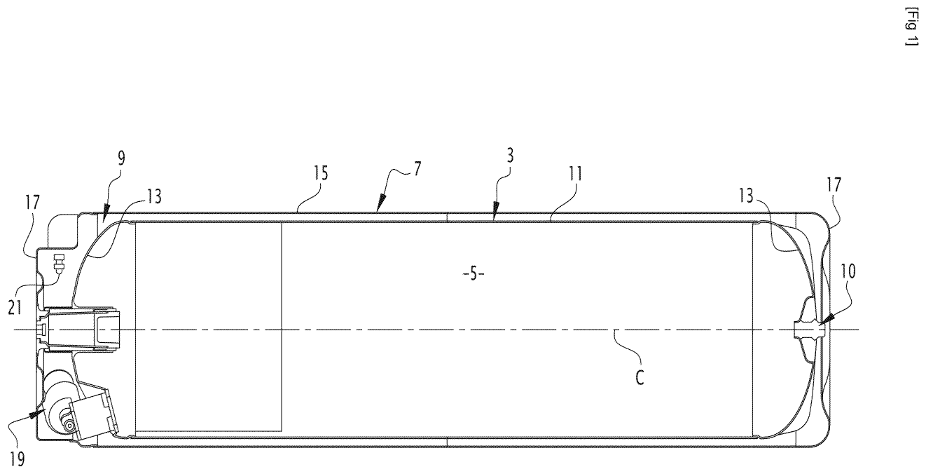

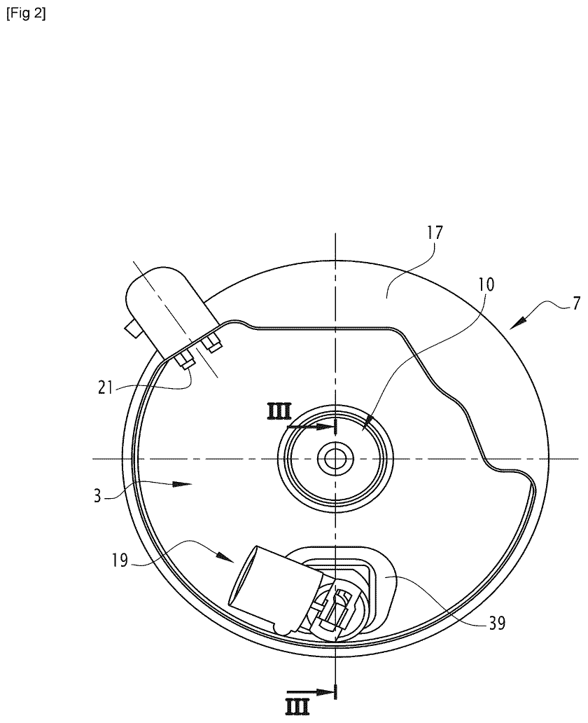

The cryogenic fluid storage unit 1 shown in FIGS. 1 to 3 is intended to store a cryogenic fluid.

Cryogenic fluid is understood to mean a fluid at a very low temperature, which may be at least partially in the liquid state inside the storage unit 1.

This fluid is typically hydrogen. Alternatively, the fluid is ammonia, a natural gas such as methane CH₄, or any other fluid suitable for an internal combustion engine. In another variant, the fluid is a cryogenic fluid such as helium, nitrogen, oxygen, or any other fluid suitable for industrial installations.

The storage unit 1 is typically intended to be installed on board a vehicle, for example a motor vehicle, a train, a boat or any other vehicle.

The motor vehicle is, for example, a car, a utility vehicle, a truck, etc.

The storage unit 1 is typically used to supply an internal combustion engine equipping a motor vehicle.

Alternatively, the storage unit 1 is designed to supply a fuel cell. For example, the fuel cell is configured to produce electricity and to electrically supply an electric propulsion motor of the vehicle.

The cryogenic fluid storage unit 1 comprises an internal reservoir 3 inwardly delimiting a cryogenic fluid storage volume 5, an external reservoir 7 housing the internal reservoir 3, the internal reservoir 3 and the external reservoir 7 being separated from one another by an intermediate space 9 maintained at low pressure.

A suspension 10 attaches the internal reservoir 3 to the external reservoir 7.

In the example shown, the internal reservoir 3 has a horizontal central axis C.

The internal reservoir 3 comprises a shell 11, closed at both opposite axial ends thereof by bottoms 13.

The shell 11 is cylindrical, centered on the central axis C.

The external reservoir 7 also has a horizontal axis.

It comprises a shell 15, closed at both opposite axial ends thereof by bottoms 17.

The shell 15 is cylindrical, centered on the central axis C.

Typically, the intermediate space 9 is maintained under a high vacuum.

This vacuum is typically of the order of 10⁻⁵ millibar, so as to strongly limit heat transfer by convection from the external reservoir 7 to the internal reservoir 3.

Thermal insulation (not shown) is interposed between the internal reservoir 3 and the external reservoir 7. The thermal insulation is typically placed on the external surface of the internal reservoir 3. The thermal insulation comprises for example a plurality of metal sheets superimposed on one another, with interposition of fiber layers.

The storage unit 1 further comprises a cryogenic fluid transfer member 19, housed in the intermediate space 9.

The transfer member 19 is configured to transfer cryogenic fluid from the storage volume 5 to other equipment, located outside the storage unit 1.

To this end, the storage unit 1 has a cryogenic fluid outlet 21. The cryogenic fluid outlet 21 is supported by the external reservoir 7. It is fluidically connected to the equipment supplied by the transfer member 19.

This equipment is for example a heat exchanger designed to heat the cryogenic fluid, or is a valve, or is the propulsion combustion engine of the vehicle, or else is a fuel cell.

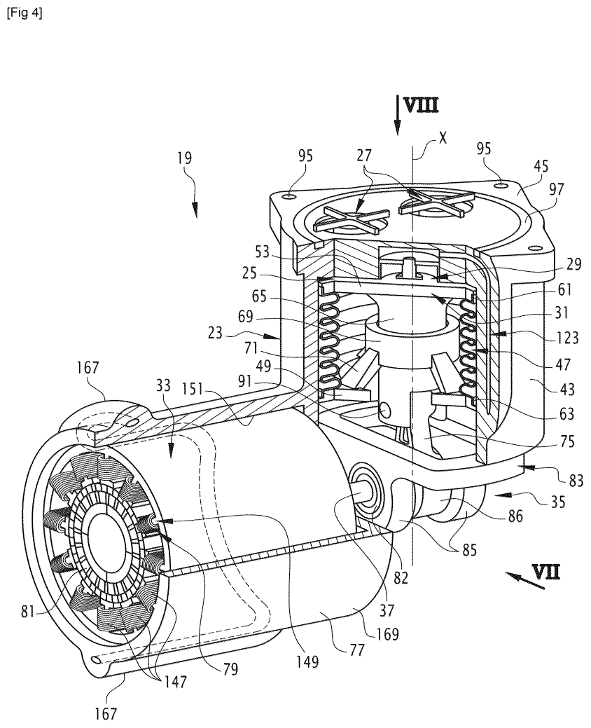

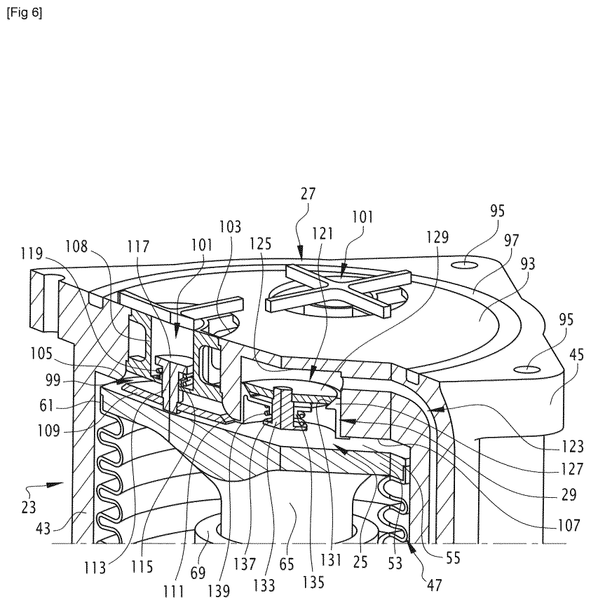

As can be seen more clearly in FIGS. 4 to 6, the cryogenic fluid transfer member 19 comprises a body 23 delimiting a chamber 25, an intake 27 placing the chamber 25 in communication with the cryogenic fluid storage volume 5, a discharge 29 comprising at least one exhaust duct 123 placing the chamber 25 in communication with the cryogenic fluid outlet 21, a movable member 31 configured to move relative to the body 23 by varying the volume of the chamber 25, a motor 33, and a mechanical transmission 35 transmitting a movement from an output shaft 37 of the motor 33 to the movable member 31.

The transfer member 19 is housed entirely within the intermediate space 9, with no part of this transfer member 19 penetrating into the cryogenic fluid storage volume 5.

The body 23 is added directly to a flange 39 attached to the internal reservoir 3.

The flange 39 is attached around an internal outlet port 41 of the internal reservoir 3, arranged at a low point of the internal reservoir 3.

The internal outlet port 41 is arranged in one of the bottoms 13.

It is arranged at a low point of the internal reservoir in the sense that it is located, in the vertical direction, immediately above the lowest point of the cryogenic fluid storage volume 5.

In the example shown, the lowest point corresponds to the generatrix of the shell 11 facing downwards. The internal outlet port 41 is arranged immediately above said generatrix. The top of the internal outlet port 41 is located, with respect to said generatrix, at a height of less than half the radius of the shell 11.

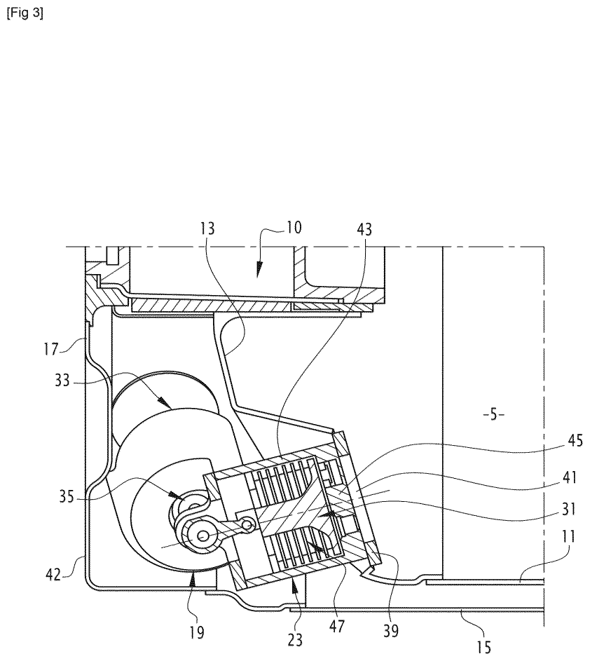

The external reservoir 7 comprises an access hatch 42 opposite the transfer member 19 (FIG. 3).

This access hatch 42 is arranged in one of the bottoms 17 of the external reservoir 7. It provides access to the transfer member 19 to perform any maintenance operations.

The body 23 comprises a cylinder 43 with a longitudinal central axis X, and a cylinder head 45 closing one longitudinal end of the cylinder 43.

The cylinder 43 is open at the longitudinal end thereof opposite the cylinder head 45.

The cylinder 43 has a circular internal cross-section perpendicular to the longitudinal axis X.

The movable member 31 is a piston which moves in the chamber 25 in the longitudinal direction X, without friction against the cylinder 43.

In other words, the transfer member 19 is of the piston pump type, thereby obtaining high discharge pressures.

The movable member 31 is connected to the body 23 by a bellows 47 isolating the motor 33 and the mechanical transmission 35 from the cryogenic fluid.

In other words, the bellows 47 creates a sealed barrier between the chamber 25 on one side, and the motor 33 and the mechanical transmission 35 on the other side.

The bellows 47 is connected in a sealed manner to the movable member 31. It is also connected in a sealed manner to the body 23, and more precisely to the internal surface of the cylinder 43.

The bellows 47 allows the movable member 31 to move and vary the volume of the chamber 25, without compromising the sealing of the chamber 25.

The transfer member 19 comprises a ring 49 rigidly attached to an internal surface 51 of the cylinder 43.

The movable member 31 comprises a head 53 arranged longitudinally between the ring 49 and the cylinder head 45.

The head 53 takes the form of a plate having, perpendicular to the longitudinal axis X, an external cross-section slightly smaller than the internal cross-section of the cylinder 43.

The head 53 has a flat surface 55 facing the cylinder head 45.

The bellows 47 is compressible in the longitudinal direction X.

The bellows 47 connects in a sealed manner the head 53 of the movable member 31 to the ring 49.

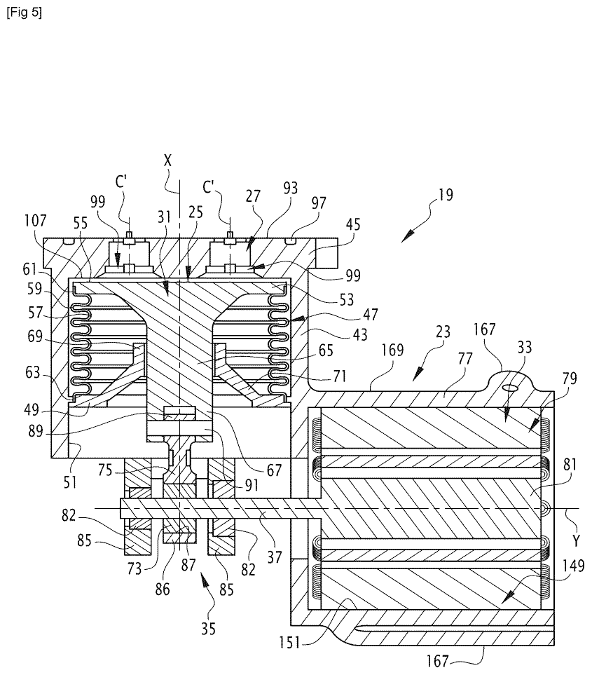

As can be seen from FIGS. 4 and 5, the bellows 47 is generally cylindrical in shape, and is coaxial with the longitudinal axis X. It is made of a metal sheet, of stainless steel, typically 316L type stainless steel, for example.

The bellows 47 has a general ribbed, that is corrugated, tube shape.

It comprises internal corrugations 57 projecting inwardly of the bellows 47, and external corrugations 59 projecting outwardly of the bellows 47. Each internal corrugation 57 is connected to two external corrugations 59, and reciprocally each external corrugation 59 is connected to two internal corrugations 57.

The internal corrugations 57 and the external corrugations 59 each extend along a closed contour around the longitudinal axis X.

Considered in section in a plane containing the longitudinal axis X, the wall of the bellows 47 has a sinuous shape.

A first longitudinal end 61 of the bellows 47 is rigidly attached to the head 53 of the movable member 31. The first longitudinal end 61 is attached in a sealed manner to the edge of the head 53, that is to the surface delimiting the head 53 in directions radially external with respect to the longitudinal axis X.

A second longitudinal end 63 of the bellows 47, opposite the first end 61, is rigidly attached to the ring 49 in a sealed manner. The ring 49 is itself attached in a sealed manner to the internal surface of the cylinder 43.

A seal is thus created between the second end 63 of the bellows 47 and the body 23.

Alternatively, the second end 63 of the bellows 47 is attached in a sealed manner directly to the internal surface of the cylinder 43.

The chamber 25 is thus delimited by the cylinder head 45, by the internal surface 51 of the cylinder 43, by the bellows 47 and by the head 53 of the movable member 31.

Its volume varies as the movable member 31 moves along the longitudinal axis X.

The travel of the movable member 31 defines the compressibility of the bellows 47.

To guarantee a very long service life for the bellows 47, the latter is designed for a billion compression/extension cycles.

According to one embodiment, this result is achieved by providing a 3 mm compression stroke for the bellows 47. This imposes a diameter of 100 mm, for example, given the desired flow rate for the transfer member 19 and the rotation speed of the motor 33.

The height of the bellows 47 is, for example, 60 mm longitudinally, and the thickness of the metal sheet constituting the bellows 47 is 1.5 mm, the bellows 47 in this case consisting, for example, of 5 plies of 0.3 mm each.

The movable member 31 further comprises a longitudinal rod 65 integral with the head 53.

The rod 65 projects from the head 53 along the longitudinal axis X, in a direction opposite to the cylinder head 45.

It extends along the central axis of the bellows 47, corresponding to the longitudinal axis X, and terminates in an end 67 located axially outside the bellows 47, but inside the cylinder 43.

Alternatively, the end 67 is located inside the bellows 47.

The transfer member 19 further comprises a ring 69 for guiding the rod 65 in longitudinal translation.

The ring 69 is housed inside the bellows 47.

The ring 69 is cylindrical and has an internal cross-section slightly larger than the external cross-section of the rod 65.

The rod 65 is engaged in the ring 69 and is free to slide inside the ring 69.

The ring 69 is rigidly attached to the ring 49.

To this end, struts 71 distributed around the longitudinal axis X rigidly connect the ring 69 to the ring 49.

The mechanical transmission 35 comprises an eccentric 73 mounted on the output shaft 37 of the motor 33 and a connecting rod 75 connecting the eccentric 73 to the rod 65.

As shown in FIGS. 4 and 5, the transfer member 19 comprises a casing 77, in which the motor 33 is housed.

The motor 33 is an electric motor, with a stator 79 and a rotor 81.

The output shaft 37 of the motor 33 is integral with the rotor 81. Alternatively, it is driven in rotation by rotor 81 via a reduction gearbox (not shown).

The output shaft 37 extends along a transverse axis Y perpendicular to the longitudinal axis X.

The transverse axis Y intersects the longitudinal axis X.

The output shaft 37 is guided in rotation by two bearings 82.

The bearings 82 are preferably made of ceramic, thereby obtaining a long service life.

As can be seen in FIG. 4, the body 23 comprises two flanges 85, carrying the bearings for rotationally guiding the output shaft 37 of the motor 33.

The two flanges 85 are parallel to each other.

The bearings 82 are housed in orifices arranged in the flanges 85.

The flanges 85 constitute a support 83 formed at the end of the cylinder 43 opposite the cylinder head 45.

The eccentric 73 and the connecting rod 75 are arranged between the flanges 85.

The eccentric 73 is rigidly attached to the output shaft 37.

The connecting rod 75 has a first end 86 comprising a circular slot 87 in which the eccentric 73 is housed. The opposite end 89 of the connecting rod 75 is rotatably connected to the end 67 of the rod 65. It is coupled to the end 67 by a rotary axis 91, extending parallel to the transverse axis Y.

The body 23 is rigidly attached to the flange 39 via the cylinder head 45.

To this end, the cylinder head 45 has a flat external face 93 opposite from the chamber 25. The external face 93 is pressed against the flange 39.

The cylinder head 45 has orifices 95 intended to receive fasteners for the flange 39, not shown in FIGS. 4 and 5.

These orifices 95 are arranged in the lugs of the cylinder head 45.

The external face 93 also features a recessed groove 97, intended to receive a seal not shown. The seal is pinched against the flange 39 when the body 23 is attached to the flange 39.

The intake 27 comprises at least one intake valve 99 mounted on the cylinder head 45.

The intake 27 comprises at least one intake passage 101 arranged through the cylinder head 45 and opening directly into the internal outlet port 41.

The at least one intake passage 101 opens directly into the chamber 25.

The at least one intake valve 99 is interposed along the at least one intake passage 101.

In the example shown, the intake 27 comprises two intake passages 101, with an intake valve 99 interposed along each intake passage 101.

Alternatively, the intake 27 comprises a single intake passage 101 and a single intake valve 99, or three intake passages 101 and three intake valves 99, or even more than three intake passages 101 and more than three intake valves 99.

In any case, it is preferable to have the largest possible total passage cross-section for the cryogenic fluid through the intake passage(s) 101. It is thereby advantageous to have several intake passages 101.

The number of intake passages 101 and the cross-section of each intake passage 101 depend on the internal diameter of the cylinder 43.

Each intake passage 101 has an upstream orifice 103 opening onto the external face 93 of the cylinder head 45, and a downstream orifice 105 opening onto the internal face 107 of the cylinder head 45.

The internal face 107 is planar. It faces the chamber 25. It is opposite the external face 93. It delimits the chamber 25.

Each intake passage 101 therefore passes through the entire thickness of the cylinder head 45.

The or each passage 101 is straight. This means that the intake passage 101 has a straight central line C′. This central line C′ is perpendicular to the external face 93 and perpendicular to the internal face 107. It is parallel to the longitudinal axis X.

The or each intake valve 99 comprises a frame 108 rigidly attached to the cylinder head 45. The frame 108 is arranged in the corresponding intake passage 101.

The or each intake valve 99 further comprises a movable plate 109 which can be moved between a closed position of the intake passage 101 and a release position of the intake passage 101.

In the closed position, the movable plate 109 rests on a seat 111 formed in the cylinder head 45, at the downstream orifice 105 of the intake passage 101. In the release position, the movable plate 109 is lifted away from the seat 111, inwardly of the chamber 25.

The movable plate 109 carries a longitudinal axis 113, engaging with a guide sleeve 115 arranged in the frame 108. The longitudinal axis 113 and the guide sleeve 115 guide the movement of the movable plate 109 longitudinally between the release position thereof and the closed position thereof.

At its end opposite the movable plate 109, the longitudinal axis 113 carries a foot 117. An elastic member 119 is interposed between the foot 117 and the frame 108. The elastic member 119 is for example a helical compression spring.

The elastic member 119 returns the movable plate 109 to the closed position.

The discharge 29 comprises at least one exhaust valve 121.

The at least one exhaust valve 121 is interposed along the at least one exhaust duct 123.

In the example shown, the discharge 29 comprises two exhaust ducts 123. Alternatively, the discharge 29 comprises a single exhaust duct 123 or three exhaust ducts 123 or more than three exhaust ducts 123.

In any case, an exhaust valve 121 is interposed along each exhaust duct 123.

The or each exhaust valve 121 is housed in a housing 125 formed in the cylinder head 45. This housing 125 forms the upstream end of the corresponding exhaust duct 123.

This housing 125 is open at the internal face 107 of the cylinder head 45 and closed at the external face 93.

The exhaust valve 121 is designed in the same way as the intake valve 99. It comprises a frame 127, integral with the cylinder head 45. This frame 127 is housed in the housing 125.

The exhaust valve 121 further comprises a movable plate 129 which can be moved between a release position of the exhaust duct 123 and a closed position of the exhaust duct 123. In the closed position, the movable plate 129 rests on a seat 131 formed in the frame 127. The seat 131 is formed in a ring-shaped portion of the frame 127, which itself is attached in a sealed manner to the internal surface of the housing 125.

In the release position, the movable plate 129 is lifted away from the seat 131, longitudinally towards the external face 93 of the cylinder head 45.

In other words, the movable plate 129 moves from the closed position to the release position along a longitudinal movement which moves it away from the internal face 107 of the cylinder head 45 and brings it towards the external face 93 of the cylinder head 45.

The movable plate 129 is integral with an axis 133 which projects longitudinally from the movable plate 129 towards the chamber 25.

The frame 127 comprises a ring 135 guiding the axis 133 in longitudinal translation.

At its opposite end to the movable plate 129, the axis 133 carries a foot 137. An elastic member 139 is interposed between the foot 137 and the frame 127. The elastic member 139 solicits the movable plate 129 towards its closed position.

The elastic member 139 is typically a helical compression spring.

The at least one exhaust duct 123 is configured to cool the motor 33.

More precisely, the stator 79 is equipped with stator windings 147, the at least one exhaust duct 123 being configured to cool the stator windings 147.

As shown in FIGS. 4 and 5, the housing 77 is tubular and coaxial with the transverse central axis Y.

The stator 79 is annular and coaxial with the transverse central axis Y.

The stator 79 comprises a sleeve 149 pressed against the internal surface 151 of the casing 77. The stator windings 147 are mounted on the sleeve 149 and are positioned radially inwardly of the sleeve 149.

The rotor 81 is cylindrical and extends along the transverse central axis Y. It is arranged inside the stator 79.

The casing 77 and the body 23 are integral. They are typically cast in one piece.

The casing 77 and/or the body 23 is advantageously made of cast aluminum or cast steel, for example 316L type cast stainless steel.

The at least one exhaust duct 123 is configured so that the cryogenic fluid conveyed by the transfer member 19 to the cryogenic fluid outlet 21 flows through the or each exhaust duct 123 in thermal contact with the stator windings 147.

The at least one exhaust duct 123 passes in immediate proximity to the stator 79.

More specifically, the at least one exhaust duct 123 comprises a cooling section 153 arranged in the casing 77.

The cooling section 153 is arranged in the casing 77 in the sense that the cooling section 153 is arranged in the material constituting the casing 77.

The cooling section 153 is the result of the casting process. In other words, the cooling section 153 is cast in one piece. It is arranged in the mass. It is not added to the casing 77.

Alternatively, the cooling section 153 is machined into the casing 77.

The at least one exhaust duct 123 comprises an intermediate section 155 fluidically connecting the cooling section 153 to the chamber 25. The intermediate section 155 is arranged in the body 23.

As previously described, the intermediate section 155 is arranged in the material constituting the body 23. It is typically cast in one piece.

The at least one exhaust duct 123 comprises at least one upstream section 157 fluidically connecting the intermediate section 155 to the chamber 25.

In the example shown, each exhaust duct 123 comprises its own upstream section 157. The intermediate section 155 and the cooling section 153 are common to the different exhaust ducts. The upstream sections 157 merge and open into the intermediate section 155.

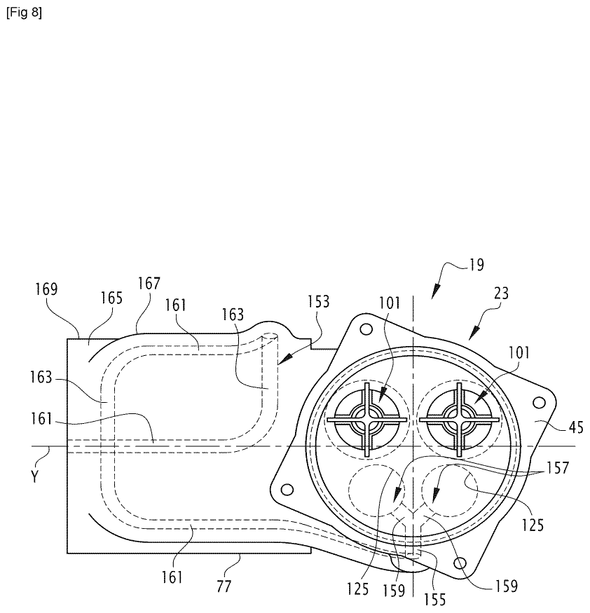

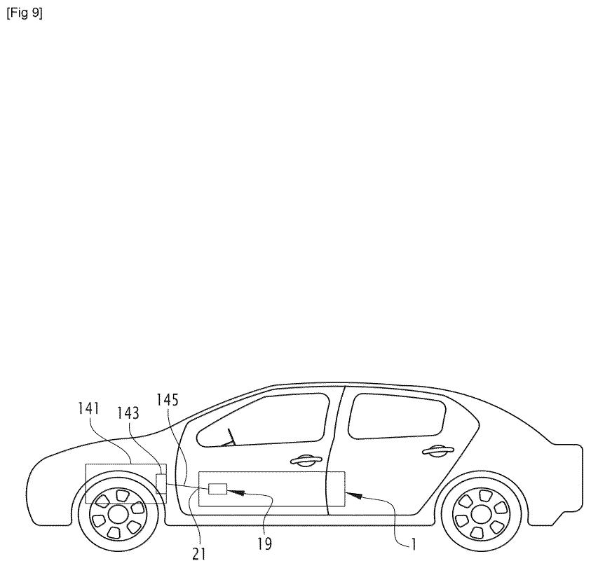

As shown in FIG. 8, the upstream sections 157 are arranged in the cylinder head 45.

Each upstream section 157 comprises the housing 125 and a branch 159 opening into a lateral surface of the housing 125.

In the example shown, the branches 159 of the two upstream sections 157 form a Y-shaped fork, from which the intermediate section 155 extends.

The intermediate section 155 extends first into the cylinder head 45, then continues into the cylinder 43.

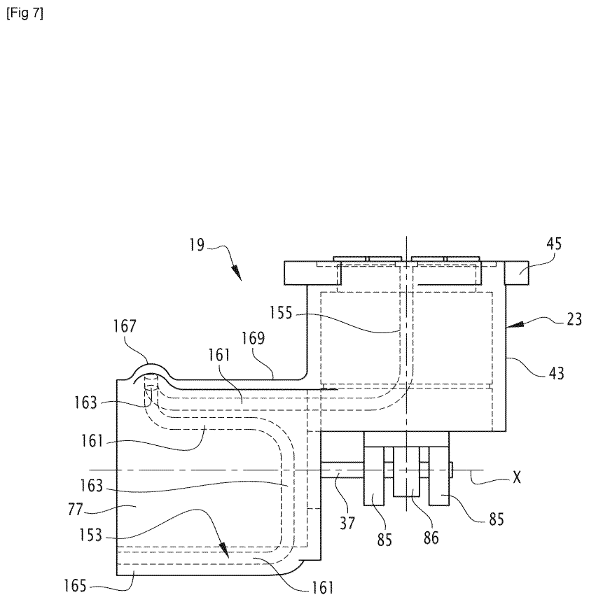

The cooling section 153, as seen in FIGS. 7 and 8, comprises a plurality of transverse portions 161 parallel to the transverse central axis Y, and a plurality of circumferential portions 163 connecting the transverse portions 161 together.

The transverse portions 161 are regularly spaced circumferentially around the transverse central axis Y. They each extend over most of the transverse length of the casing 77.

The circumferential portions 163 connect the end of one transverse portion 161 to the end of a neighboring transverse portion 161.

In the example shown, the cooling section 153 comprises three transverse portions 161 connected to each other by two circumferential portions 163. One of the transverse portions 161 is directly connected to the intermediate section 155. Another of the transverse portions 161 is connected to the cryogenic fluid outlet 21 by a duct not shown.

As shown in FIGS. 7 and 8, the casing 77 has a cylindrical part 165 coaxial with the transverse central axis Y and thickened portions 167 projecting from an external surface 169 of the cylindrical part 165. The cooling section 153 is arranged in the thickened portions 167.

The thickened portions 167 form ribs on the external surface 169 of the cylindrical part 165. The ribs follow the shape of the cooling section 153.

Similarly, the body 23 also carries a rib in which the intermediate section 155 is arranged.

The operation of the transfer member 19 will now be detailed.

The motor 33 rotates the output shaft 37.

The eccentric 73 rotates with the output shaft 37, inside the circular slot 87 arranged in the big end of the connecting rod 75. The connecting rod 75 converts the rotational movement of the output shaft 37 into a translational movement of the movable member 31. This moves longitudinally in a reciprocating motion, first away from the cylinder head 45 and then in the opposite direction towards the cylinder head 45.

Under the effect of this reciprocating motion, the bellows 47 is alternately compressed then longitudinally stretched.

When the movable member 31 descends, that is moves away from the cylinder head 45, the or each intake valve 99 opens under the effect of the pressure difference between the cryogenic fluid storage volume 5 and the chamber 25. This pressure difference is sufficient to overcome the return force of the elastic member 119. On the other hand, the or each exhaust valve 121 remains closed, the movable plate 129 being returned to its closed position by the elastic member 139 and by the pressure in the exhaust duct 123.

Cryogenic fluid can thus flow from the cryogenic fluid storage volume 5 into the chamber 25, through the or each intake passage 101.

As the movable member 31 rises, that is approaches the cylinder head 45, the pressure inside the chamber 25 increases. This leads to the closing of the or of each intake valve 99. The movable plate 109 is moved into its closed position under the effect of the pressure difference between the chamber 25 and the cryogenic fluid storage volume 5, and under the effect of the return force of the elastic member 119. Conversely, the or each exhaust valve 121 opens, as the movable plate 129 is moved into its release position under the effect of the pressure prevailing in the chamber 25. This pressure is sufficient to overcome the return force of the elastic member 139.

The cryogenic fluid is then expelled through the exhaust duct(s) 123.

The cryogenic fluid flows through the upstream sections 157, then through the intermediate section 155 to the cooling section 153.

It runs through the cooling section 153 and cools the motor 33.

The cryogenic fluid passes through various transverse portions 161 distributed all around the motor 33, such that said motor is cooled around its entire periphery.

The cryogenic fluid flows through the thickness of the wall of the casing 77, such that the heat released by the stator windings 147 is transmitted by conduction to the cryogenic fluid.

After having run through the cooling section 153, the cryogenic fluid flows directly to the cryogenic fluid outlet 21, without passing back into the cryogenic fluid storage volume 5.

FIG. 7 shows a motor vehicle comprising an internal combustion engine 141 and a storage unit 1 as described hereinbefore.

The internal combustion engine 141 is of the type adapted to operate using cryogenic fluid as fuel.

It comprises combustion chambers 143. The transfer member 19 of the storage unit 1 conveys the cryogenic fluid into the combustion chambers 143 of the internal combustion engine 141.

To do this, the cryogenic fluid outlet 21 is fluidically connected to the combustion chambers 143 by a duct 145.

The transfer member 19 is configured to convey the cryogenic fluid at a pressure of between 25 and 200 bar, preferably 40 and 120 bar, and even more preferably 50 and 100 bar.

In the cryogenic fluid storage volume 5, the cryogenic fluid is stored at a pressure of between 1 and 20 bar.

The transfer member 19 is therefore a high-pressure transfer member, enabling the cryogenic fluid pressure to be raised significantly, from the storage pressure in the cryogenic fluid storage volume 5 to the injection pressure in the combustion chambers.

The storage unit 1 disclosed hereinbefore has multiple advantages.

When the motor is an electric motor comprising a rotor and a stator equipped with stator windings, the at least one exhaust duct being configured to cool the stator windings, the motor is particularly well cooled. The stator windings release a significant amount of heat.

When the transfer unit comprises a casing in which the motor is housed, the at least one duct comprising a cooling section arranged in the casing, the cryogenic fluid circulates in the material constituting the casing. This contributes to the efficacy of the engine cooling.

When the casing and the body are integral, it is particularly easy to arrange the flow of the cryogenic fluid.

The fact that the at least one exhaust duct comprises an intermediate section fluidically connecting the cooling section to the chamber, the intermediate section being arranged in the body, helps to facilitate the arrangement of the flow of the cryogenic fluid.

The fact that the casing is tubular and has a transverse central axis, the cooling section comprising a plurality of transverse portions parallel to the central axis, and a plurality of circumferential portions connecting the transverse portions together, means that the casing is particularly well cooled. This contributes to correct engine cooling.

When the casing has a cylindrical part coaxial with the central axis and thickened portions protruding from an external surface of the cylindrical part, the cooling section being arranged in the thickened portions, the arrangement of the cooling section in the material constituting the casing is facilitated.

When the casing is made of cast aluminum or cast steel, the dissipation of heat by diffusion is particularly good.

When the body comprises flanges carrying bearings for guiding the output shaft of the motor in rotation, the heat released by the magnets of the motor can be evacuated by conduction along the output shaft of the motor, then through the bearings and the flanges to the body of the transfer member. This latter is cooled by the circulation of cryogenic fluid.

The storage unit may have multiple variants.

The internal reservoir and the external reservoir can be arranged in different orientations. They are not necessarily horizontal axes but can for example be vertical axes.

The mechanical transmission is not necessarily of the eccentric connecting rod type. The mechanical transmission can be of the crank-rod type, a connecting rod transmission, or any other suitable type of transmission.

The motor is not necessarily arranged as shown in the figures, with an output shaft at right angles with respect to the direction of movement of the movable member. The motor can be of any type suitable for moving the movable member.

In a non-preferred variant, the at least one exhaust duct is not arranged in the material constituting the casing of the motor. It is attached to the casing and/or to the body of the transfer member.

The body and the casing can be two separate elements, attached to each other, and not integral with each other.

The cooling section can be designed differently from what has been described hereinbefore. It can, for example, be wound helically around the central axis Y, or adopt any other suitable shape. The cooling section may, for example, comprise several branches arranged in parallel, served by a distribution manifold, all of which open into a discharge manifold connected to the cryogenic fluid outlet.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A cryogenic fluid storage unit, the cryogenic fluid storage unit comprising:
an internal reservoir internally delimiting a cryogenic fluid storage volume that stores cryogenic fluid;
an external reservoir, in which the internal reservoir is housed, the internal reservoir and the external reservoir being separated from each other by a low-pressure intermediate space;
a cryogenic fluid transfer member housed in the low-pressure intermediate space, the cryogenic fluid transfer member comprising a body delimiting a chamber, an intake placing the chamber in communication with the cryogenic fluid storage volume, a discharge comprising at least one exhaust duct placing the chamber in fluid communication with a cryogenic fluid outlet outside the cryogenic fluid storage unit, a movable member configured to move relative to the body by varying a volume of the chamber, a motor, and a mechanical transmission transmitting a movement from an output shaft of the motor to the movable member; and
the at least one exhaust duct being configured to cool the motor.

2. The cryogenic fluid storage unit according to claim 1, wherein the motor is an electric motor comprising a rotor and a stator equipped with stator windings, the at least one exhaust duct being configured to cool the stator windings.

3. The cryogenic fluid storage unit according to claim 1, wherein the cryogenic fluid transfer member comprises a casing in which the motor is housed, the at least one exhaust duct comprising a cooling section arranged in the casing.

4. The cryogenic fluid storage unit according to claim 3, wherein the casing and the body are integral.

5. The cryogenic fluid storage unit according to claim 4, wherein the at least one exhaust duct comprises an intermediate section fluidically connecting the cooling section to the chamber, the intermediate section being arranged in the body.

6. The cryogenic fluid storage unit according to claim 3, wherein the casing is tubular and has a transverse central axis, the cooling section comprising a plurality of transverse portions parallel to the transverse central axis, and a plurality of circumferential portions connecting the plurality of transverse portions together.

7. The cryogenic fluid storage unit according to claim 6, wherein the casing has a cylindrical part coaxial with the transverse central axis and thickened portions projecting from an external surface of the cylindrical part, the cooling section being arranged in the thickened portions.

8. The cryogenic fluid storage unit according to claim 3, wherein the casing is made of cast aluminum or cast steel.

9. The cryogenic fluid storage unit according to claim 3, wherein the body comprises flanges carrying bearings for rotationally guiding the output shaft of the motor.

10. A vehicle comprising an internal combustion engine having combustion chambers and the cryogenic fluid storage unit according to claim 1, the cryogenic fluid transfer member conveying the cryogenic fluid into the combustion chambers of the internal combustion engine.
